(19) United States
(12) Patent Application Publication
(10) Pub. No.: US 2018/0198349 A1
(43) Pub. Date: Jul. 12, 2018

(54) SUPPORT ELEMENT, IN PARTICULAR STATOR SUPPORT ELEMENT AND/OR ROTOR SUPPORT ELEMENT, SYSTEM OF SUPPORT ELEMENTS, GENERATOR SUPPORT, GENERATOR, GENERATOR SUPPORT SYSTEM, NACELLE OF A WIND TURBINE, WIND TURBINE AND METHOD FOR ASSEMBLING A GENERATOR SUPPORT SYSTEM

(71) Applicant: Wobben Properties GmbH, Aurich (DE)

(72) Inventor: Florian SARTORIUS, Leer (DE)

(21) Appl. No.: 15/741,173

(22) PCT Filed: Jun. 27, 2016
(86) PCT No.: PCT/EP2016/064881

§ 371 Date: Dec. 29, 2017

(30) Foreign Application Priority Data
Jul. 2, 2015 (DE) 10 2015 212 452.5

(51) Int. Cl. H02K 7/18; H02K 1/30; H02K 1/18; H02K 3/46; H02K 15/02; F03D 9/25; F03D 80/80; F03D 15/20

(52) U.S. Cl. CPC H02K 7/1838; H02K 1/30; H02K 1/187; F03D 15/20; H02K 15/02; F03D 9/25; F03D 80/82; H02K 3/46

(57) ABSTRACT

A support element for a support of a ring generator, in particular a stator support element for a stator support of a ring generator, and/or a rotor support element for a rotor support of a ring generator, wherein, to form the support, a number of support elements are assembled over a generator surface and which support is designed with an outer-circumferential supporting ring for the attachment of a winding and with an inner-circumferential supporting shoulder, in particular for linking up with a pin for connection to a bed plate. It is provided that the support element has: a leg, preferably a single leg in the form of a segment of a circle, which is assigned to a sector of an area of the generator surface and is designed for the assembly of the supporting ring, the leg being provided, in particular integrally, with the supporting shoulder that extends over part of the inner circumference, for attachment to a fully circumferential supporting flange, in particular the fully circumferential supporting flange being provided for linking up with a pin for connection to a bed plate, the supporting shoulder having a first fitting element and the supporting flange having a second fitting element, the first and second fitting elements being made to match one another, in particular as a female part and a male part.

### BACKGROUND

### Technical Field

The invention relates to a support element for a support of a ring generator, in particular a stator support element for a stator support of a ring generator, and/or a rotor support element for a rotor support of a ring generator, wherein, to form the respective support, a number of support elements are assembled over a generator surface and which support is designed with an outer-circumferential supporting ring for the attachment of a winding and with an inner-circumferential supporting shoulder, in particular for linking up with a pin for connection to a bed plate.

The invention also relates to a system of a multielement support with a number of support elements, in particular to a multielement stator support and/or to a multielement rotor support. The invention also relates to a corresponding generator support.

The invention also relates to a generator, to a generator supporting system and also to a nacelle and to a wind turbine and to a method for assembling a generator supporting system.

### Description of the Related Art

A wind turbine, in particular a horizontal-axis wind turbine, has proven successful, in particular as a gearless wind turbine. In such a case of a gearless wind turbine—which is explained here at the beginning by way of example, but in principle is not intended to be restrictive for the invention—an aerodynamic rotor directly drives the rotor of a generator, so that the kinetic energy obtained from the wind is converted into electrical energy by interaction of the electromagnetic fields in the generator between the rotor and the stator.

In the case of a gearless wind turbine, the rotor of the generator turns at the speed of the aerodynamic rotor, and consequently with a comparatively slow rotational speed, for which reason such a generator is also referred to as a slow runner. On account of the comparatively high number of poles of the winding, the nominal speed reached with a given feeding frequency is therefore lowered significantly. A slow runner of the aforementioned type with a high number of poles accordingly has a correspondingly great diameter, which may be several meters, which in principle is advantageous. It is problematic in this case however that a slow runner that is provided as the generator for a gearless wind turbine—and to this extent is preferably formed as a synchronous generator—may have a diameter which significantly exceeds widths that are customarily transported by road. Thus, for example, a typical airgap diameter, measured at the air gap between the rotor and the stator, may be ten meters or twenty meters or more, while a maximum width for road transport may for example be only about five meters.

It is known in principle, as described for example in DE 10 2012 208 547 A1, to design an external rotor of a synchronous generator of a gearless wind turbine in a multipart form, while the stator should be undivided.

DE 101 28 438 A1 and DE 100 33 233 A1 disclose various stator supports for a stator of a generator of a wind turbine. Such stator supports are not suitable however for dividing the generator, as desired for transport. Rather, they demand that the generator is completed at the factory on the supports described there and transported in an undivided state. Thus, the ring generator described in DE 100 33 233 A1 has a stator and a rotor, the stator having a supporting structure by means of which the stator ring and the stator winding are held. The supporting structure is formed by a number of supporting arms consisting of a structure made up of bars.

It is known in principle from DE 100 40 273 A1 to provide a generator arrangement that has at least two stators, with in each case at least one stator winding, each stator being assigned at least one electrical phase—preferably consisting of a rectifier, an inverter and a transformer. For example, four stators may be provided, it being possible for each individual stator to be exchanged while the other stators are retained.

The German Patent and Trademark Office has searched the following document in the priority application relating to the present PCT application: DE 10 2008 050 848 A1.

However, with all of the approaches described in the aforementioned documents, it remains problematic that the structural divisions (with regard to the supports) or functional divisions (with regard to the electrical phase) of a generator described therein are already still in need of structural improvement.

### BRIEF SUMMARY

Provided is a support element, a support, in particular a stator support element for a stator support of a ring generator and/or a rotor support element for a rotor support of a ring generator, a system of a multielement support, a generator support, a generator supporting system, and a generator by means of which the aforementioned transporting problems can be solved in an improved way. Preferably, it is intended in addition or possibly as an alternative to this that the structure or the construction and the assembly of the support can be implemented in an improved way.

In particular, provided is a generator and, on the basis thereof, a support element and a support. Preferably, the generator is designed as a synchronous generator and slow runner with a comparatively great diameter, in particular a diameter of an air gap of ten meters and more. An object is in particular to design it in a dividable state such that it can nevertheless be transported and/or assembled in a comparatively improved way.

In particular, it is intended that a nacelle of a wind turbine can be advantageously assembled. In particular, provided is a corresponding nacelle and a wind turbine that benefit from the support element. In particular, an improved method for assembling a generator supporting system, in particular together with the rotor, is to be provided, it being intended that transport of a support element and/or assembly of the generator supporting system are performed in a comparatively simplified manner. In particular, provided is to make the assembly and installation of the support elements at an installation site of a wind turbine and/or the assembly of a supporting system in the nacelle of the wind turbine comparatively simple, in any event to obtain an improvement in comparison with the prior art.

For the support element for a support of a ring generator (in particular for a stator support element for a stator support of a ring generator and/or for a rotor support element for a rotor support of a ring generator), it is provided that, to form the support, a number of support elements are assembled over a generator surface and which support is designed with an outer-circumferential supporting ring for the attachment of a winding and with an inner-circumferential supporting shoulder, in particular for linking up with a pin for connection to a bed plate.

It is also provided that the support element has:
a leg, preferably a single leg and/or a leg in the form of a segment of a circle, which is assigned to a first sector of an area of the generator surface and is designed for the assembly of the supporting ring,
the leg being provided, in particular integrally, with the supporting shoulder that extends over part of the inner circumference, for attachment to a fully circumferential supporting flange, in particular the fully circumferential supporting flange being provided for linking up with a pin for connection to a bed plate,
the supporting shoulder having a first fitting element and the supporting flange having a second fitting element, the first and second fitting elements being made to match one another in a fitting manner, in particular as a female part and a male part. Preferably, they are made to match one another in an exactly fitting manner.

The invention is based on the idea that, in the case of a support element for forming the support with a number of support elements over a generator surface while assembling the same, until now it has been necessary that an outer-circumferential supporting ring and/or an inner-circumferential supporting flange must be additionally and subsequently assembled onto a leg of a support element, in a way that is inadequate.

The invention has recognized that, in the case of the support element, it can be advantageously provided that, to form the support, a number of support elements are assembled over a generator surface and the support is designed with an outer-circumferential supporting ring for the attachment of a winding and/or with an inner-circumferential supporting shoulder, in particular for linking up with a pin for connection to a bed plate. Accordingly, the concept of the invention with regard to the support element provides in the way mentioned above:
a leg, preferably a single leg in the form of a segment of a circle, which is assigned to a sector of an area of the generator surface and is designed for the assembly of the supporting ring,
the leg being provided, in particular integrally, with the supporting shoulder that extends over part of the inner circumference, for attachment to a fully circumferential supporting flange, in particular the fully circumferential supporting flange being provided for linking up with a pin for connection to a bed plate,
the supporting shoulder having a first fitting element and the supporting flange having a second fitting element, the first and second fitting elements being made to match one another in a fitting manner, in particular as a female part and a male part. Preferably, they are made to match one another in an exactly fitting manner.

Accordingly, the concept of the invention with regard to the stator support element provides:
a stator leg, preferably a single stator leg in the form of a segment of a circle, which is assigned to a sector of an area of the generator surface and is designed for the assembly of the stator supporting ring,
the stator leg being provided, in particular integrally, with the stator supporting shoulder that extends over part of the inner circumference, for attachment to a fully circumferential supporting flange, the fully circumferential supporting flange being intended as a receiving flange for attachment to the receiving pin for connection to a bed plate, the stator supporting shoulder having a first fitting element and the receiving flange having a second fitting element, the first and second fitting elements being made to match one another in a fitting manner, in particular as a female part and a male part. Preferably, they are made to match one another in an exactly fitting manner.

In particular, it is provided that the stator leg is integrally provided with the supporting shoulder that extends over part of the inner circumference for attachment to a fully circumferential receiving flange.

Accordingly, the rotor support element provides:
a rotor leg, preferably a single rotor leg in the form of a segment of a circle, which is assigned to a sector of an area of the generator surface and is designed for the assembly of the rotor supporting ring,
the rotor leg being provided, in particular integrally, with the rotor supporting shoulder that extends over part of the inner circumference, for attachment to a fully circumferential supporting flange, the fully circumferential supporting flange being provided as a hub flange for attachment to a hub, the hub being provided on a journal for connection to a receiving pin and the latter to a bed plate,
the rotor supporting shoulder having a first fitting element and the hub flange having a second fitting element, the first and second fitting elements being made to match one another in a fitting manner, in particular as a female part and a male part. Preferably, they are made to match one another in an exactly fitting manner.

In particular, it is provided that the rotor leg is integrally provided with the supporting shoulder that extends over part of the inner circumference for attachment to a fully circumferential hub flange.

Provided is a generator support and to a generator with such a generator support or support, in particular with a stator support and/or a rotor support.

Provided is a generator, having:
a receiving pin for supporting the stator, optionally for attachment to or furthermore also having a bed plate, the stator support with the stator supporting shoulder that extends over part of the inner circumference being attached to the receiving pin for releasably fixed connection to the receiving flange, and/or
a journal for the attachment of a rotor hub, the rotor support with the rotor supporting shoulder that extends over part of the inner circumference being provided on the rotor hub for attachment to the hub flange,
optionally also the rotor with the rotor hub and rotor blades, the rotor hub being provided on a journal for connection to a receiving pin and the latter optionally to a bed plate.

Provided is a nacelle having a rear nacelle casing and a generator supporting system and also a rotor, comprising the rotor hub, with a continuation of the rear nacelle casing.

Provided is a wind turbine, which is designed in particular as a gearless wind turbine. The wind turbine has:
a tower with a top flange, and
a nacelle with a generator supporting system, the bed plate being connected to the top flange and the nacelle having a rear nacelle casing, and also
with a rotor comprising a rotor hub as a continuation of the rear nacelle casing.

The concept of the invention also leads to a method for assembling a generator supporting system, in which
the stator support, with the stator supporting shoulder and the receiving flange, is attached to the receiving pin,
the rotor hub is pre-mounted on the journal for the forming of a hub bearing arrangement, in particular at the factory, and the journal receives the rotor hub in a bearing manner,
the rotor support, with the rotor supporting shoulder and the hub flange, is attached to the rotor hub, and
the hub bearing arrangement with the journal is placed onto the receiving pin of the bed plate, and
the number of rotor blades for forming the rotor are fitted onto the number of blade flange bearings of the rotor hub, and
the parts thus assembled are attached to the bed plate, in particular in the case of an erected tower with a top flange.

Provided is an advantage that, by means of the support elements, during the assembly of the support, the supporting ring is also assembled at the same time, assembly of the support on a generator supporting system being made comparatively easily possible, in particular by the provision of a supporting flange that extends over the entire circumference and is adjoined, in particularly integrally, by a leg with the supporting shoulder that extends over part of the inner circumference.

In particular, it is provided that, by means of the stator support elements designed for the assembly of the stator support and/or rotor support elements designed for the assembly of the rotor support, the stator supporting ring or rotor supporting ring is also assembled at the same time, assembly of the stator support or rotor support on a generator supporting system being made comparatively easily possible by the provision of a receiving flange that extends over the entire inner circumference or a hub flange that extends over the entire inner circumference and is adjoined, preferably integrally, by the leg, preferably the single leg in the form of a segment of a circle, by means of a supporting shoulder that extends over part of the inner circumference. That is to say that the preferably integral stator leg, which is designed for the assembly of the stator supporting flange, adjoins a receiving flange that extends over the entire inner circumference and the preferably integral rotor leg, which is designed for the assembly of the rotor supporting flange, adjoins a hub flange that extends over the entire inner circumference.

When assembling the support elements, an additional working step is avoided in that, when assembling the support elements, at least one corresponding outer-circumferential supporting ring of the support is also assembled at the same time. Furthermore, a supporting flange that extends over the entire inner circumference, i.e., the receiving flange or the hub flange, is a particularly reliable means of ensuring that the supporting shoulders that extend over part of inner circumference are aligned, in particular centered, for the assembly on the inner-circumferential supporting flange, and are assigned to a pin of the generator supporting system.

It is for this purpose also provided that the supporting shoulder has a first fitting element and the supporting flange has a second fitting element, the first and second fitting elements being made to match one another in a fitting manner, in particular as a female part and a male part.

With regard to the stator support element, it is provided that the stator supporting shoulder has a first fitting element and the receiving flange has a second fitting element, the first and second fitting elements being made to match one another in a fitting manner, in particular as a female part and a male part. Preferably, they are made to match one another in an exactly fitting manner.

With regard to the rotor support element, it is provided that the rotor supporting shoulder has a first fitting element and the hub flange has a second fitting element, the first and second fitting elements being made to match one another in a fitting manner, in particular as a female part and a male part. Preferably, they are made to match one another in an exactly fitting manner.

The support elements offer the advantage that they can be designed as already weatherproof. This relates in particular to the attachment of a stator winding to the stator supporting ring segment of the stator support element or the attachment of a rotor winding to the rotor supporting ring segment of the rotor support element. This makes it possible to provide a generator—as a so-called outdoor generator—which, in the case of a nacelle, between a rotor hub and a rear nacelle casing extends beyond the profile of the nacelle casing thus defined, in other words protrudes from the nacelle.

Preferably, for this purpose a stator support and/or a rotor support of a system for assembly may be temporarily connected for the formation of a generator support, and
the generator support, in particular as part of a generator, with a temporarily connected stator support and rotor support is attached to a receiving pin of the bed plate,
the stator support being attached to the receiving pin by the stator supporting shoulder and the receiving flange, and/or
the rotor support being attached to the rotor hub by the rotor supporting shoulder and the hub flange and a journal receiving the rotor hub in a bearing manner.

In particular, the rotor support element for a rotor support of a ring generator may be introduced laterally along a radius, i.e., perpendicularly in relation to a centering axis.

Provided is an ability of arranging a support element—that is to say in particular a stator support element or a rotor support element—along a line of a sector of an area of the leg in the form of a segment of a circle on a transporting vehicle, in particular of arranging it longitudinally along the line of a sector of an area of the leg in the form of a segment of a circle. In that case, the support element can nevertheless be provided in a way corresponding to the length of the sector of an area for a synchronous generator as a slow runner with a comparatively great diameter. In short, a support element, in particular a stator support element or a rotor support element, may well have a length of ten meters, twenty meters or more along the sector of an area. Thus, even with comparatively narrow roads, for example of five meters or less, a support element can be transported separately from other support elements; i.e., a multipart support can be transported after being broken down into its support elements. Nevertheless, the number of support elements can be assembled comparatively easily to form a support. In particular, a number of stator support elements can be assembled comparatively easily to form a stator support or a number of rotor support elements can be assembled comparatively easily to form a rotor support. The inner-circumferential supporting flange—that is to say the receiving flange for the plurality of stator support elements and the hub flange for the plurality of rotor support elements—is preferably of an integral form and the outer-circumferential supporting flange of the support is also formed at the same time during the assembly of the support elements.

Advantageous developments of the invention can be taken from the subclaims and specifically provide advantageous possibilities for realizing the concept explained above within the scope of the object and with regard to further advantages.

For the sake of simplicity, sometimes reference is made hereinafter to a support element, this being understood as meaning a stator support element or a rotor support element or a stator support element and a rotor support element. Similarly, sometimes reference is made to a support, this being understood as meaning a stator support or a rotor support or a stator support and a rotor support. Similarly, for the sake of simplicity, sometimes reference is made hereinafter to a supporting ring for a stator supporting ring and/or rotor supporting ring or to a supporting flange for a stator supporting flange and/or rotor supporting flange. Similarly, for a stator or rotor, sometimes reference is made hereinafter generally to a leg, supporting arm, supporting ring or supporting ring segment or seat flange.

It has proven to be advantageous within the scope of a development that the leg has a radially extending supporting arm and, adjoining the supporting arm, a supporting ring segment that extends over the outer circumference, for forming the supporting ring.

It may be advantageous for the supporting ring to be formed with a mutually turned arrangement of different support elements, and consequently with a circumferential offset of various supporting ring segments.

In particular, it has proven to be advantageous that, additionally or alternatively, a supporting ring segment adjoins, in particular integrally adjoins, one or more supporting arms of the leg. For example, a leg may have one, two, three or more supporting arms—in a way similar to an arrangement of spokes—to which a supporting ring segment is connected in a suitable way, in particular is integrally connected. In principle, a leg may have one, two or more supporting arms.

For example, it has proven to be advantageous that a supporting arm and/or a leg take the form of a flat part covering the sector of an area. The flat part may for example be formed as a spoked part that has a first and a second supporting arm or more supporting arms; for example, three, four or five supporting arms.

The angle segment of the full outer-circumferential angle of the supporting ring that is passed over by the supporting ring segment is preferably dependent on how great a number of support elements there are for forming the support. If, for example, as preferred, three support elements—in particular stator support elements for forming a stator support or rotor support elements for forming a rotor support—are provided, it has proven to be advantageous that a leg has in each case three, four, five or six supporting arms, which are together adjoined, preferably integrally, at the outer circumference by a supporting ring segment. If, for example, as also preferred, three support elements—in particular stator support elements for forming a stator support or rotor support elements for forming a rotor support—are provided, it has proven to be advantageous that each leg provides three, four or five supporting arms, to which a corresponding supporting ring segment is connected, preferably integrally.

In particular, it has proven to be advantageous that, additionally or alternatively, the supporting ring is to be formed with a turned arrangement of various support elements—in particular stator support elements or rotor support elements—and consequently with a circumferential offset of various supporting ring segments. If, for example, a number of three supporting elements is provided for forming a support, with in each case a leg, each leg advantageously passes over a sector of the area of the generator surface that corresponds to a circumferential angle of 120°. If, on the other hand, four support elements are provided, each leg advantageously passes over a sector of the area of the generator surface that corresponds to a circumferential angle of 90°.

A supporting ring segment may, but does not have to, be connected in a supporting and secure manner to a laterally neighboring supporting ring segment of another support element during the assembly of the support elements. In particular in the case of a supporting ring segment integrally adjoining a supporting arm, a support element proves however to be sufficiently stable, so that even a gap can remain between the neighboring supporting ring segments after the assembly of the support elements.

With regard to the fitting elements with an adjusting effect, it is preferably provided that
the first fitting element is designed as a groove that extends over part of the inner circumference or a similar female part on the supporting shoulder that extends over part of the inner circumference and the second fitting element is designed as a fully circumferential tongue or similar male part on the fully circumferential supporting flange; or (conversely)
the first fitting element is designed as a tongue that extends over part of the inner circumference or a similar male part on the supporting shoulder that extends over part of the inner circumference and the second fitting element is designed as a fully circumferential groove or similar female part on the fully circumferential supporting flange.

Each of the fitting elements, in particular a circumferential groove or similar female part and/or a circumferential tongue or similar male part, may be produced with comparatively little effort on the supporting shoulder and/or supporting flange along with the supporting shoulder and/or supporting flange as a turned part when machining on a lathe as a working step during production. On the other hand, the advantages of easy, exactly fitting assembly of the supporting shoulder and the supporting flange at the construction site are considerable.

In particular, the first fitting element and/or the second fitting element may have a front face and a side face, the front face extending obliquely in relation to the side face. In particular, it may be provided that
the front face extends parallel to the connection plane of the supporting shoulder and of the supporting flange and the side face extends at an angle other than a right angle to the front face, and/or
the side face extends at a right angle to the connection plane of the supporting shoulder and of the supporting flange and the front face extends at an angle other than a right angle to the side face, and/or
the side face extends at an angle other than a right angle to the connection plane of the supporting shoulder and of the supporting flange and the front face extends in a plane other than parallel to the connection plane of the supporting shoulder and of the supporting flange.

Preferably, the supporting shoulder and/or the supporting flange has a perforation for leading through a screw, a bolt or similar holding element, such as for example for forming a screw connection, in order to securely connect the supporting shoulder and the supporting flange to one another in a releasable manner. In particular, the perforation may comprise a row of holes with a plurality of holes for leading through a plurality of screws, bolts or similar holding elements, in order to securely connect the supporting shoulder and the supporting flange to one another in a releasable manner.

With regard to the stator support element, it has proven to be particularly advantageous that
the first stator supporting arm and the second stator supporting arm integrally adjoin the stator supporting shoulder that extends over part of the inner circumference radially in relation to a centering axis, in particular the stator supporting shoulder that extends over part of the inner circumference is designed to be securely connected in a releasable manner to the receiving flange and/or the receiving flange is designed to be securely connected in a releasable manner to the receiving pin.

Preferably, a stator supporting arm and/or stator leg may take the form of a flat part covering the first and second sectors of an area, in particular a spoked part, in particular in the way explained above.

With regard to the stator support element, it has proven to be particularly advantageous that the first and second stator supporting arms are adjoined by a stator supporting ring segment that is in the form of a bordering frame and T-shaped in cross section, in particular centrally. This measure has proven to be particularly advantageous for forming a stator support to be arranged within the rotor support.

In particular, this measure is advantageous for the case where the rotor is provided as an external rotor on the generator.

Accordingly, it has also proven to be advantageous that the first and second rotor supporting arms are adjoined by a rotor supporting ring segment that is in the form of a bordering frame and L-shaped in cross section, in particular laterally. To this extent, the rotor support can, in graphic terms, be of an approximately pot-like design, by the stator support being inserted while leaving an air gap. The aforementioned developments with regard to the stator support element and rotor support element concerning the arrangement of the bordering frame take these ideas into account in a particularly preferred way.

With regard to the rotor support element, it has proven to be particularly advantageous that
the first rotor supporting arm and the second rotor supporting arm integrally adjoin the rotor supporting shoulder that extends over part of the inner circumference radially in relation to a centering axis, in particular the rotor supporting shoulder that extends over part of the inner circumference is designed to be securely connected in a releasable manner to the hub flange and/or the hub flange is designed to be securely connected in a releasable manner to the hub.

In particular, a rotor supporting arm and/or rotor leg may take the form of a flat part covering the sector of an area, in particular a spoked part.

With regard to the system comprising a multielement stator support with a number of stator support elements and/or a multielement rotor support with a number of rotor support elements, it has proven to be particularly advantageous that each of the support elements can be removed from another support element and attached again. In particular, each of the support elements can be removed from another support element and attached again with an electrical generator function of its own. In particular, it can be ensured in this way that, even with the electrical generator function, the support elements can be transported separately.

For providing a generator function, it has already proven to be advantageous if the support elements have corresponding windings on the supporting ring and the connection cabling and the pole packs.

With regard to the generator support, it has proven to be advantageous that at least one stator support or at least one rotor support or at least one stator support and at least one rotor support is/are provided

In particular, it is also possible that the generator support is formed with at least one stator support, in combination with an undividable, that is to say in particular single-element, rotor support. In particular, it has proven to be advantageous that this is formed with at least one rotor support, in combination with an undividable, in particular single-element, stator support. Such a development takes into account that, if appropriate, a stator or rotor should be transported in an undivided state, if it tends to be advantageous to form it completely as a single element at the factory.

With regard to the generator, it has accordingly proven to be particularly advantageous that each of the stator support elements and rotor support elements is designed with an electrical connection of its own, which is provided for making available its own operational generator function.

The concept of the invention consequently extends not only to stator support elements or rotor support elements as mentioned above, but also to stator elements or rotor elements comprising in each case a support element and the associated complete generator function with the corresponding windings and electrical connections. To this extent it is ensured that a generator with for example at least two, three or four or more stator elements and at least two, three or four or more rotor elements is already operational even when only one of the stator elements and rotor elements is operational.

Within the scope of a particularly preferred development, it may be provided for the generator that on each of the stator support elements with a stator winding and/or on each of the rotor support elements with a rotor winding, that is to say for the purpose of an own operational generator function, in each case an own operational connection is provided to a power supply connection for the own operational generator function. In particular, it is provided for the operational connection that in each case a rectifier, a DC conductor, an inverter and a transformer are connected to a stator element, that is to say a stator support element with a stator winding, and/or a rotor element, that is to say a rotor support element with a rotor winding.

Provided is an advantageous way the basis for the development of the nacelle with the generator supporting system, it being possible for the generator supporting system with the generator to be surrounded by the nacelle casing and the rotor hub.

In principle, the support elements, in particular a stator element or rotor element with corresponding windings, can also be of a weatherproof design, so that the generator supporting system can be surrounded by the nacelle casing, the generator protruding between the rotor hub and the rear nacelle casing.

Within the scope of the method, it has proven to be particularly advantageous that the rotor hub is pre-mounted on the journal for the forming of a hub bearing arrangement. This can in particular take place at the factory.

It is also provided within the scope of the development of the method that the hub bearing arrangement with the journal is placed onto the receiving pin of the bed plate. This considerably simplifies the assembly at the installation site of the wind turbine if, as mentioned, the hub bearing arrangement is already pre-mounted on the journal.

Subsequently, the number of rotor blades for forming the rotor can be fitted onto the blade flange bearings of the rotor hub. Advantageously, the rotor hub has three blade flange bearings for three rotor blades.

Within the scope of the method, the generator is advantageously fitted as a synchronous generator for a gearless wind turbine in the form of a ring generator.

Exemplary embodiments of the invention are now described below on the basis of the drawing. The drawing is not necessarily intended to show the exemplary embodiments to scale, but rather takes a schematized and/or slightly distorted form wherever this is useful for explanatory purposes. For additions to the teachings that are directly evident from the drawing, reference is made to the relevant prior art. At the same time, it must be taken into account that a wide variety of modifications and changes relating to the form and detail of an embodiment can be made without departing from the general concept of the invention. Moreover, the scope of the invention covers all combinations of at least two of the features disclosed in the description, the drawing and/or the claims. The general concept of the invention is not limited to the exact form or the detail of the preferred embodiment shown and described below or limited to a subject matter that would be restricted in comparison with the subject matter defined in the claims. Where dimensional ranges are specified, values lying within the stated limits are also intended to be disclosed as limit values and able to be used and claimed as desired. For the sake of simplicity, the same designations are used below for parts that are identical or similar or parts that have an identical or similar function.

### BRIEF DESCRIPTION OF THE SEVERAL VIEWS OF THE DRAWINGS

Further advantages, features and details of the invention emerge from the following description of the preferred exemplary embodiments and on the basis of the drawing, in which

specifically:

FIG. 1 shows the basic construction of a wind turbine with a tower and a nacelle, in the present case as a gearless wind turbine with a synchronous generator as a slow runner in the form of a ring generator—within the scope of a particularly preferred embodiment;

FIG. 2 shows a longitudinal section through the nacelle of the wind turbine of FIG. 1 including representation of the generator supporting system with a generator, that is to say in particular with a top flange of the tower, a bed plate, a receiving pin and a journal and a rotor hub mounted on it, according to a preferred embodiment;

FIG. 3 shows a perspectively simplified representation of the generator supporting system as explained in detail with reference to FIG. 2, according to a preferred embodiment, the only part of a generator that is shown being the generator support between the receiving pin on the bed plate and the rotor hub on the journal;

FIG. 4 shows a simplified representation of the top flange of the tower with the bed plate and the receiving pin and also the receiving flange for the stator support, as explained with reference to FIG. 3;

FIG. 5A shows a simplified representation of the partially assembled stator support with a stator support element on the receiving flange of FIG. 4;

FIG. 5B shows a perspective representation of a turned arrangement of various stator support elements, in the present case three, and with a circumferential offset of the various stator supporting ring segments of the stator supporting ring for forming a complete stator support on the receiving flange of FIG. 5A;

FIG. 6 shows a perspective representation of the stator support on the receiving flange of the receiving pin and also with the attached journal for applying a rotor hub for a generator supporting system;

FIG. 7 shows a perspective representation of the rotor support with a turned arrangement of various rotor support elements, in the present case three, and consequently with a circumferential offset of the various rotor supporting ring segments of the rotor supporting ring on a hub flange on the rotor hub of a rotor for attachment on the journal of FIG. 6;

FIG. 8 shows a flow diagram for carrying out an assembling method, in particular at an installation site of a wind turbine, for a generator supporting system, in particular with reference to FIG. 9 to FIG. 13;

FIG. 9A shows an exploded view for explaining the assembly of a stator support as in FIG. 5B, according to a first step of the assembling method of FIG. 8;

FIG. 9B shows a detailed representation of a preferred embodiment of a stator supporting shoulder with a first fitting element and a receiving flange as a supporting flange with a second fitting element, the first and second fitting elements—here as a female part comprising a groove that extends over part of the inner circumference and a male part comprising a fully circumferential tongue—, being made to match one another, according to a first step of the assembling method of FIG. 8;

FIG. 10 shows a perspective representation for explaining the bearing arrangement of the rotor hub with the hub flange on the journal during assembly, said journal being attached to the receiving pin (as shown in FIG. 6), the receiving flange of the receiving pin holding the stator support according to a second and third step of the assembling method of FIG. 8;

FIG. 11 shows an exploded view for explaining the assembly of the rotor support as in FIG. 7 on the partially assembled generator support or generator supporting system of FIG. 10, a rotor support element having been pushed in radially for attachment by its rotor supporting shoulder to the fully circumferential hub flange according to a fourth step of the assembling method of FIG. 8;

FIG. 12 shows a perspective representation for explaining the assembly of the rotor blades for the rotor on the partially assembled generator support or generator supporting system of FIG. 11 according to a fifth step of the assembling method of FIG. 8;

FIG. 13 shows in an exploded view the attachment of the assembled generator support with rotor to the bed plate with flanging-on of the receiving pin to the bed plate to complete the generator supporting system according to a sixth step of the assembling method of FIG. 8.

### DETAILED DESCRIPTION

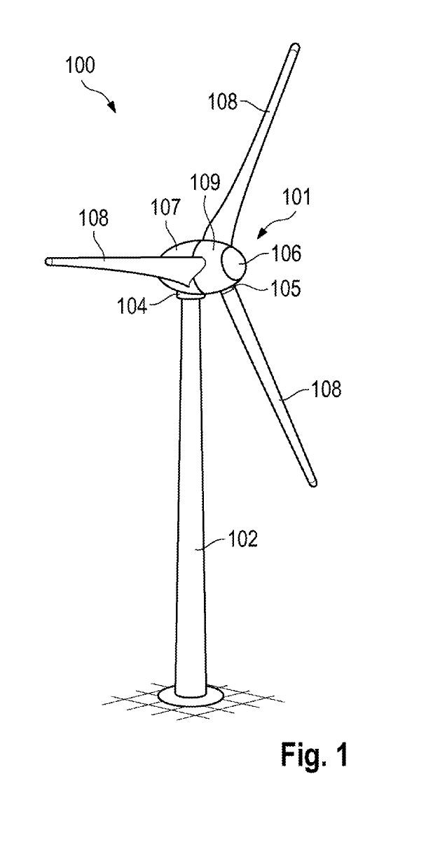

FIG. 1 shows a wind turbine 100 in perspective view with a tower 102 and a nacelle 101, which is arranged on the tower 102 and has a rotor hub 109 with three rotor blades 108. The nacelle 101 also has a rear nacelle casing 107, which adjoins the rotor hub 109 and surrounds the non-rotating part of the nacelle 101 that is not shown any more specifically; that is to say for instance the bed plate explained further below, the generator, the power electronics, etc.; according to a preferred embodiment, the generator, with a correspondingly large diameter—for instance with the outer circumferential region of the rotating rotor (external rotor)—may in this case protrude from the nacelle 101 between the rotor hub 109 and the adjoining rear nacelle casing 107.

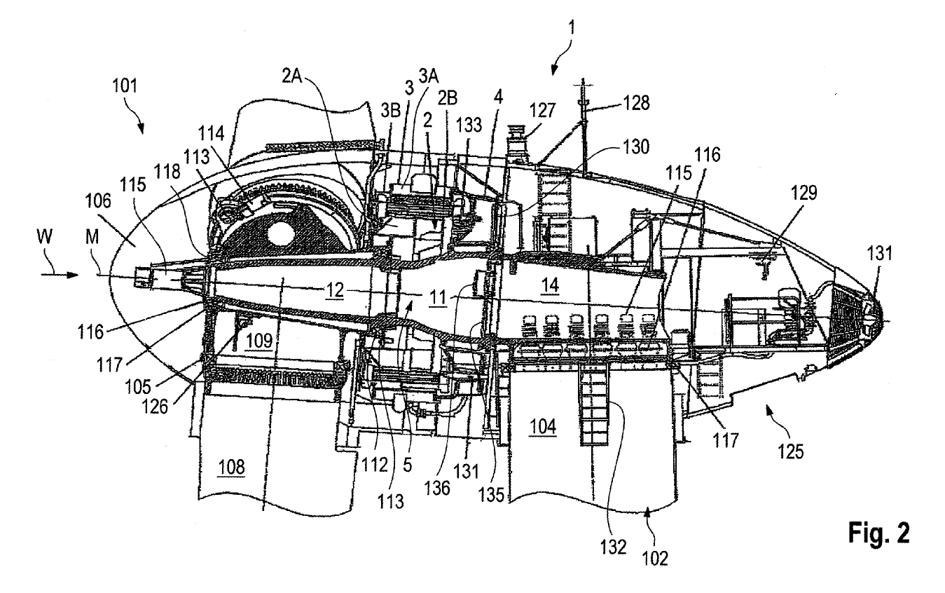

Also shown on the rotor hub is a so-called spinner casing 106, which is directed as intended into the wind. The region of the spinner casing 106 is also referred to as the front part of the nacelle 101 or the front nacelle casing. To this extent, the nacelle 101 is divided in principle between a front region of the spinner casing 106, the rotor hub 109 and a rear region of the rear nacelle casing 107. In the region where the rotor blades 108 are attached, a rotor blade root is attached to a blade flange bearing 105, which holds a rotor blade 108 in a way that is not indicated any more specifically in FIG. 2—rotor hub 109 with spinner casing 106 and rotor blade root with blade flange bearing 105 and rotor blades 108 is also referred to as the rotor.

The tower 102 has a top flange 104, onto which a bed plate 14 indicated more specifically in FIG. 2 is fitted, in order to provide and make available the internals that are accommodated in the nacelle 101, in particular here the generator supporting system 5, the generator 1 and various power electronics, etc.

Not shown in detail in FIG. 1 are the usual electrical devices for the connection of a wind turbine to a public supply system and the various power electronics, such as rectifiers, DC conductors, inverters and transformers—these may be accommodated as appropriate in the nacelle 101, in the tower 102 or separately from that in a switch cabinet in the direct vicinity of the wind turbine 100 or (for example in the case of a wind farm or an offshore wind turbine) in a switch cabinet that is comparatively remote from the wind turbine 100.

FIG. 2 shows the basic construction and the internals of the nacelle 101, which for this purpose is shown in a sectional view along a longitudinal section; along an axis M, which corresponds essentially to an oncoming wind direction W. The internals and attachments of the nacelle 101 that are shown in FIG. 2 essentially comprise the following elements: a rotor blade 108, a blade flange bearing 105, a blade adjusting gear mechanism 113, a blade adjusting motor 114, a slip ring assembly 115, an axial cover 116, a front bearing cover 117, a double-row tapered roller bearing 118 and the aforementioned rotor hub 109. The slip ring assembly 115 is in the present case accommodated within the spinner casing 106.

A generator supporting system 5 has at least one journal 12 and a receiving pin 11 for attachment to a bed plate 14 at the top flange 104 of the tower 102; a generator supporting system 5 may also be understood as including at least one journal 12 and a receiving pin 11 and a bed plate 14 for attachment to a top flange 104 of the tower 102. Also depicted are a cylindrical roller bearing 112, a rear bearing cover 113 and an azimuth bearing arrangement with an azimuth motor 115, an azimuth gear mechanism 116, an azimuth bearing 117 and also the aforementioned tower 102 with the aforementioned top flange 104.

The nacelle 101 additionally has a central lubricating system 126, approach lighting 127 and a combined wind sensor 128. An electric chain hoist 129 allows equipment to be transported into the nacelle 101 or out from it through a load hatch 125 below; the electric chain hoist has a load-bearing capacity of for example 250 kilograms.

One of the ways in which the nacelle 101 can be accessed is via the tower 102, that is to say by way of an entry ladder 132, which reaches from the tower 102 to the nacelle 101. For this purpose, an entry hatch that is not indicated any more specifically is provided through the top flange 104 of the tower 102.

For ventilating the nacelle 101, it has a nacelle fan 130 and a passive tail fan 131.

The journal, receiving pin and bed plate 10, 11, 14 serve as a generator supporting system for receiving and supporting a generator 1 that is explained in more detail below. The generator 1 is designed in the present case as a ring generator in the form of a slow running synchronous generator. The rotor 3 of the generator 1 may be fixed in relation to the stator 2 by means of an electromagnetic brake caliper 131 and an arresting means 133; for example to fix the rotor 3 in relation to the stator 2 for servicing purposes.

The generator 1 shown in FIG. 2 is formed as a ring generator with a rotor 3 and a stator 2. The rotor 3 has a rotor support 3A, on which a rotor winding 3B has been applied to pole packs. The stator 2 has a stator support 2A, on which a stator winding 2B has been applied to stator packs. The stator 2 is secured by means of a stator bell 4 to the receiving pin 11, which in turn is attached to the bed plate 14. The rotor 3 is connected to the rotor hub 109 and turns along with it, the rotor hub 109 being mounted in a rotating manner on the journal 12 by means of said tapered roller bearings 118 and cylindrical roller bearings 112. The generator 1 is consequently formed as an external-rotor generator with an inner-lying stator and an outer-lying rotor 2, 3. The arrangement of a bed plate 14 with a flanged-on receiving pin and journal 11, 12 to this extent forms a generator supporting system 5, attached to the top flange 104 of the tower 102, for the generator 1 or with the generator 1. The rotor support 3A is to this extent supported indirectly by the journal 12; the stator support 2A is to this extent supported directly by the receiving pin 11.

The generator supporting system 5 is in the present case of a hollow design and is arranged along a center axis M. The center axis M to this extent forms an axis of rotation for the rotor 3 and a central axis for the journal 12, the receiving pin 11 and the bed plate 14. Also provided in the receiving pin is an insert 135 with a blower 136 in the receiving pin 11. The blower 136 can consequently move the air into the interior space of the generator supporting system 5 comprising the bed plate 14, the receiving pin 11 and the journal 12. Furthermore, the generator 1 with the rotor 3 and the stator 2 is shown with the assigned stator support 2A and rotor support 3A.

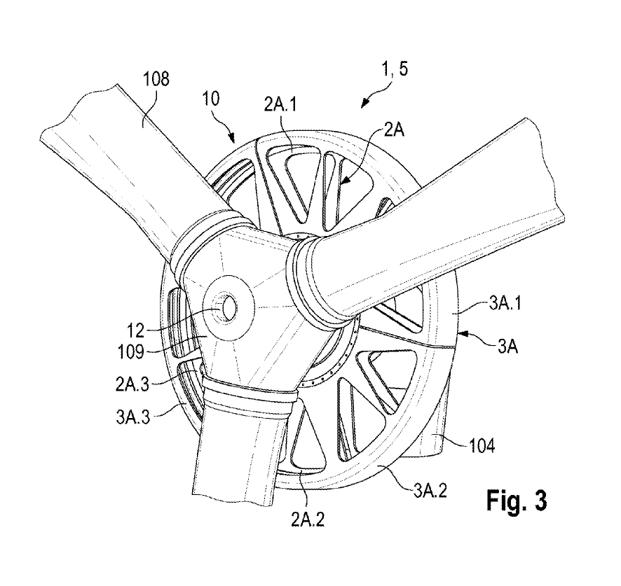

The generator supporting system 5 with the generator 1 is shown in the following FIG. 3 in a representative manner by means of the generator support 10 (that is to say then without the generator 1) on the bed plate 14 with the receiving pin 11 and the journal 12, and in FIG. 3 the rotor is also shown The rotor hub 109 of the rotor mounted on the journal 12 is in this case depicted with the blade flange bearings 105 for the rotor blades 108 of the rotor.

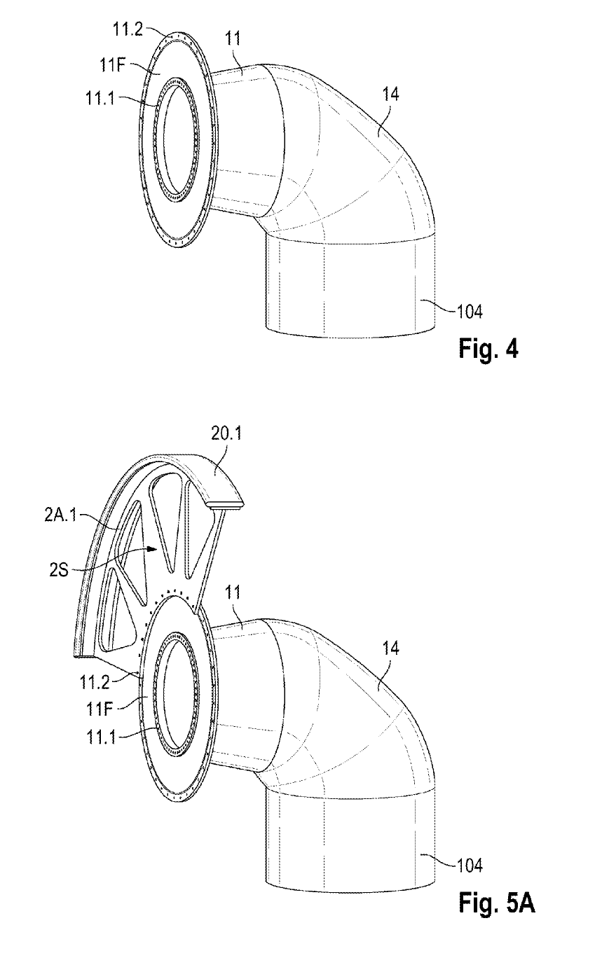

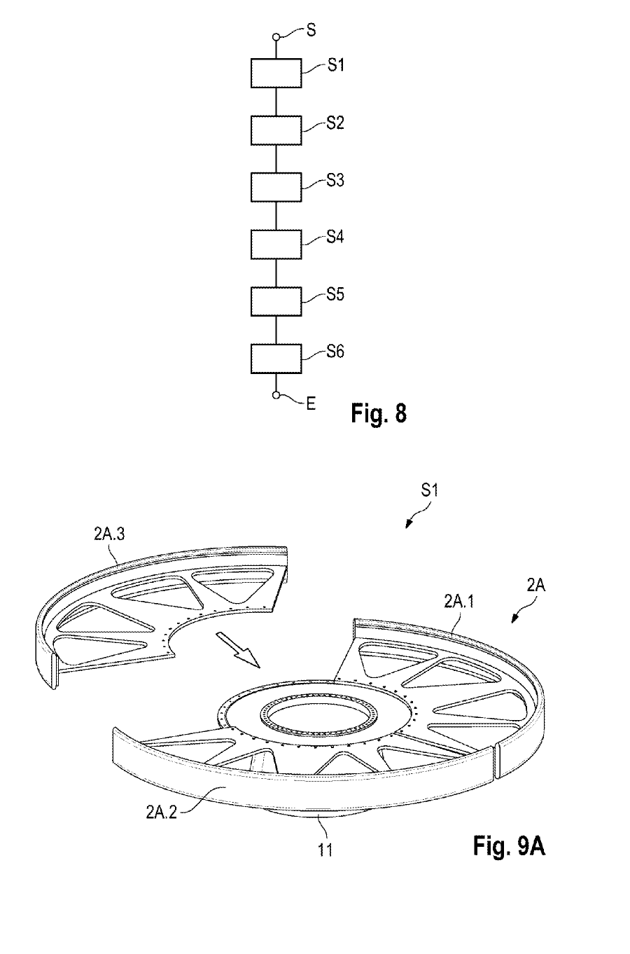

Each of the supports 2A, 3A is formed with a number of stator support elements 2A.1, 2A.2, 2A.3 or rotor support elements 3A.1, 3A.2, 3A.3 that are not shown any more specifically in FIG. 3. This construction is specifically explained in principle on the basis of the following FIG. 4 to FIG. 6 and FIG. 7. An assembling method for the generator support is explained in FIG. 8 to FIG. 13.

Specifically, FIG. 3 and FIG. 4 show in this respect the top flange 104 of the tower 102 with the bed plate 14 fitted on it and the receiving pin 11 flanged on it. The receiving pin 11 is to this extent attached at the end face of the bed plate 14.

It is also evident in FIG. 4 that the receiving pin 11 is provided with a receiving flange 11F. The fully circumferential supporting flange in the form of the receiving flange 11F is in the present case joined onto the receiving pin 11 or attached by means of an annular series of screw connections 11.1 provided over the inner circumference. Additionally or alternatively, the annular series of screw connections 11.1 provided over the inner circumference may also serve for the attachment of the journal 12 to the receiving pin 11. The receiving flange 11F has furthermore an outer-circumferential perforation for leading through a screw, a bolt or similar holding element, in order to securely connect a supporting shoulder of a stator support element 2A.1, 2A.2, 2A.3 and the receiving flange 11F to one another in a releasable manner; that is to say here an annular series of holes for providing screw connections 11.2.

On the outer circumference of the receiving flange, the stator support elements 2A.1, 2A.2, 2A.3 of the stator support 2A are attached as explained below.

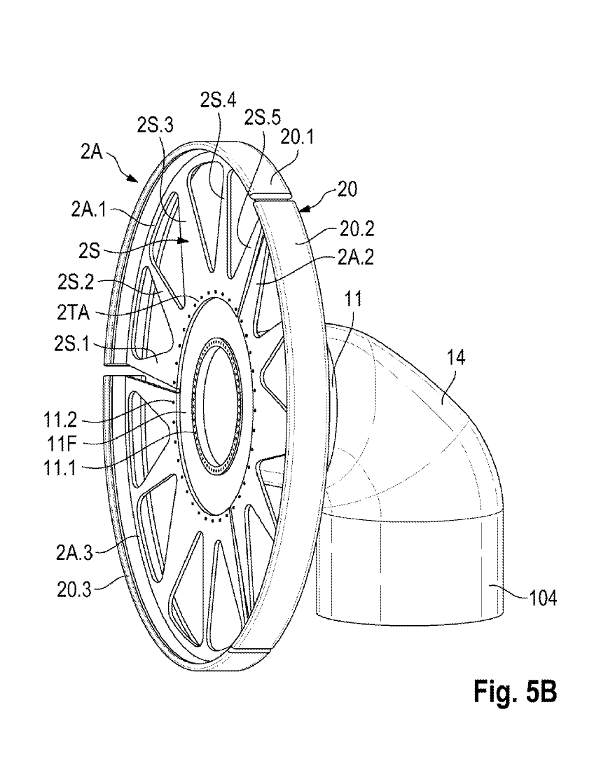

As can be seen from FIG. 5A, a number of stator support elements are provided, in the present case three stator support elements 2A.1, 2A.2, 2A.3, which are arranged turned in relation to one another and releasably attached to the receiving flange 11F by way of the screw connections 11.2 mentioned. FIG. 5B shows specifically in this respect the in this case three stator support elements 2A.1, 2A.2, 2A.3 in the attached state on the receiving flange 11F, in the present case the stator support elements being attached at a 0 o'clock, 4 o'clock and 8 o'clock position and in each case covering an angle of 120°. The three stator support elements 2A.1, 2A.2, 2A.3 are structurally essentially identical, and consequently respectively assigned in the way mentioned a sector of an area of the generator surface; in the present case, the sector of the area therefore passes over an angle of 120°.

As can also be seen from FIG. 5B, each of the stator support elements 2A.1, 2A.2, 2A.3 has a stator leg 2S, which has a number of radially extending stator supporting arms, in this case five stator supporting arms 2S.1, 2S.2, 2S.3, 2S.4, 2S.5. Over the inner circumference, all of the stator legs 2S together form a fully circumferential stator supporting shoulder 2TA. The stator supporting arms 2S.1, 2S.2, 2S.3, 2S.4, 2S.5 of the stator leg 2S are adjoined at the outer circumference by a stator supporting ring segment 20.1. With the mentioned turned arrangement of the in this case three stator support elements 2A.1, 2A.2, 2A.3, consequently various stator supporting ring segments 20.1, 20.2, 20.3 are assembled for forming the stator supporting ring 20.

A stator leg 2S is formed by the stator supporting arms 2S.1, 2S.2, 2S.3, 2S.4, 2S.5, in the present case in the form of a flat part covering the sector of an area of 120°. The stator leg 2S is therefore formed here by the stator supporting arms as a spoked part. The stator supporting ring segment 20.1, 20.2, 20.3 for forming the stator supporting ring 20 takes the form here of a bordering frame and, T-shaped in cross section, is connected to the stator supporting arms 2S.1, 2S.2, 2S.3, 2S.4, 2S.5, connected centrally.

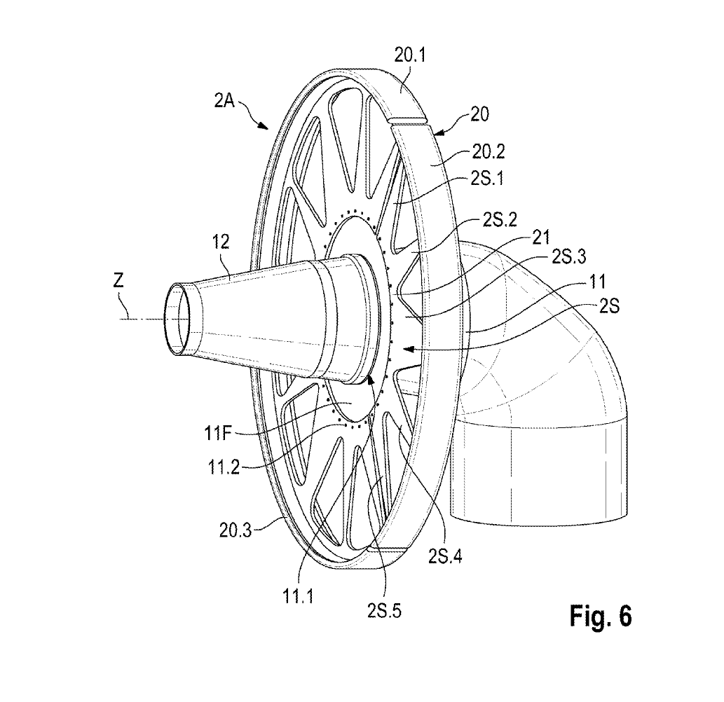

According to FIG. 6, each stator supporting arm 2S.1, 2S.2, 2S.3, 2S.4, 2S.5 is integrally connected to a stator supporting shoulder 21 that extends over part of the inner circumference, here radially in relation to a centering axis Z. All of the stator supporting shoulders 21 of the three stator support elements 2A.1, 2A.2, 2A.3 that extend over part of the inner circumference together form the fully circumferential stator supporting shoulder 2TA. The stator supporting shoulder 21 itself is intended for secure connection in a releasable manner to the receiving flange 11F by means of the aforementioned annular series of screwing means 11.2. The receiving flange 11F itself is in turn intended for the secure connection in a releasable manner to the receiving pin 11 by way of the aforementioned annular series of screw connections 11.1. This annular series of screw connections 11.1 may also serve as in the present case for the attachment of a journal 12, as shown in FIG. 6. Alternatively, the receiving flange 11F may also be joined to the receiving pin in an unreleasable manner, and the annular series of screw connections 11.1 may be used exclusively for the attachment of the journal 12.

The designations used in FIG. 6 for the stator leg 2S with the stator supporting arms 2S.1, 2S.2, 2S.3, 2S.4, 2S.5 apply in the same way for all the essentially structurally identical stator support elements 2A.1, 2A.2, 2A.3, and are therefore also used in FIG. 5B for the first stator support element 2A.1 and in FIG. 6 also for the second stator support element 2A.2; for the sake of overall clarity, these are not also entered for the third stator support element 2A.3

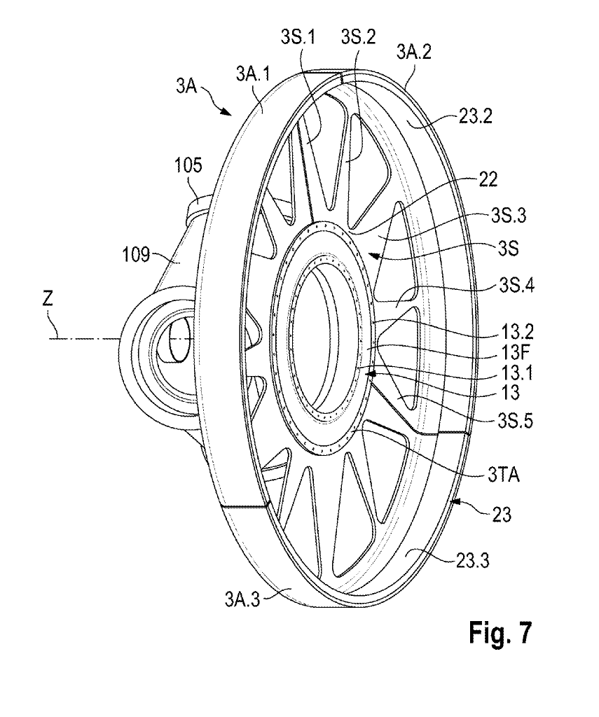

Furthermore, as already explained, a rotor support element 3A.1, 3A.2, 3A.3 with a corresponding designation of the features specific to a rotor 3 is constructed in a way analogous to a stator support element 2A.1, 2A.2, 2A.3 of FIG. 5A and FIG. 5B. In this respect, in FIG. 7, the analogous notation of parts is used for a rotor support element 3A.1, 3A.2, 3A.3 of a rotor support 3A. Each rotor support element correspondingly has a rotor leg 3S with a rotor supporting shoulder 22 that extends over part of the inner circumference. All of the rotor supporting shoulders 22 of the three rotor support elements 3A.1, 3A.2, 3A.3 that extend over part of the inner circumference together form a fully circumferential rotor supporting shoulder 3TA. Extending radially from the rotor supporting shoulder 22, the rotor leg 3S has a number of rotor supporting arms, in the present case five rotor supporting arms 3S.1, 3S.2, 3S.3, 3S.4, 3S.5.

Very much by analogy with the stator support 2A for forming the stator supporting ring 20, also in the case of the rotor support 3A for forming a rotor supporting ring 23 there is provided in each case a rotor supporting ring segment 23.1, 23.2, 23.3 adjoining at least one, here all, of the rotor supporting arms 3S.1, 3S.2, 3S.3, 3S.4, 3S.5 of the rotor leg 3S and extending over the outer circumference.

With in this case three rotor support elements 3A.1, 3A.2, 3A.3, each rotor support element is assigned to a sector of an area of 120° and covers the latter as a flat part. Each rotor leg 3S is therefore formed in the present case as a spoked part, with the rotor supporting arms 3S.1, 3S.2, 3S.3, 3S.4, 3S.5. A rotor supporting ring segment 3A.1, 3A.2, 3A.3 forms altogether the rotor supporting ring 30 as a bordering frame, which is L-shaped in cross section and laterally adjoins the rotor supporting arms 3S.1, 3S.2, 3S.3, 3S.4, 3S.5.

In FIG. 7, it is also evident that each rotor supporting shoulder 22 is arranged radially in relation to a centering axis, which is essentially also the axis for arranging the journal 12; and on the latter the axis for arranging the rotor hub 109 with blade flange bearings 105. FIG. 7 shows to this extent a rotor support 3A with the rotor support elements 3A.1, 3A.2, 3A.3 for forming an essentially pot-shaped rotor support 3A, which adjoins a hub flange 13F of the part of the rotor hub 13 on the nacelle side that is shown here (in FIG. 2—designation 109 for the front part of the rotor hub on the spinner side). The hub flange 13F serves here as a fully circumferential supporting flange for the rotor support 3A, the hub flange 13F preferably being joined on here to the rotor hub 13 at the inner circumference and having an outer-circumferential annular series of screw connections 13.2, connected to which there is in each case a partially circumferential rotor supporting shoulder 22 of a rotor leg 3S of the three rotor support elements 3A.1, 3A.2, 3A.3, that is to say for forming a fully circumferential rotor supporting shoulder 3TA.

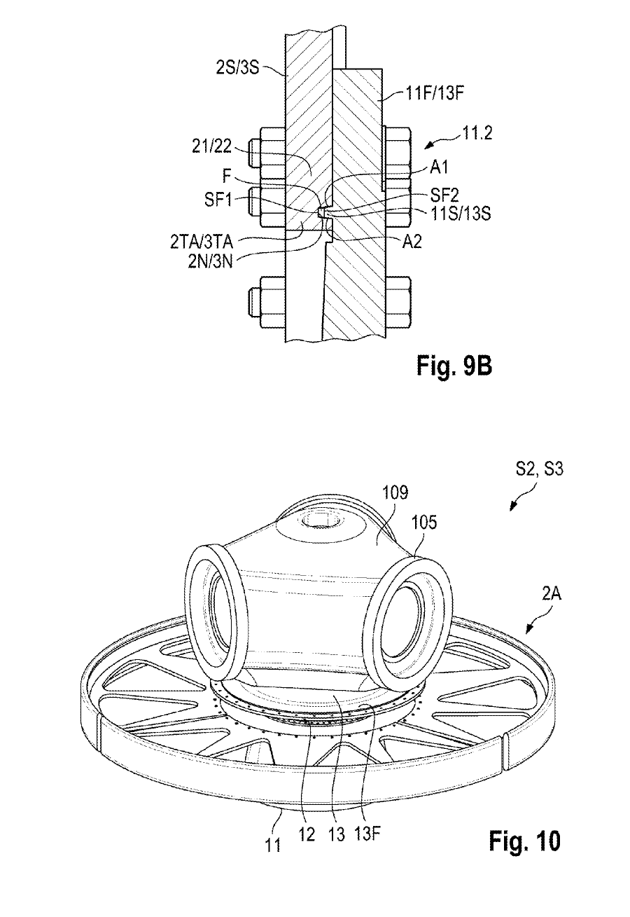

FIG. 8 shows in a flow diagram the basic method steps for the preferred assembly, that is to say in particular on-site assembly at the installation site of a wind turbine, of a generator supporting system 5 with a generator support 10; this is specifically explained in FIG. 9 to FIG. 13, to which reference is also made. To this extent, FIG. 3 to FIG. 7 serve for explaining the basic construction and another assembling method.

The preferred assembling method provides in a first step S1 that the stator support is assembled as a multielement stator support 2A with a number of stator support elements 2A.1, 2A.2, 2A.3, as explained in detail on the basis of FIG. 9A and FIG. 9B.

As can also be seen from FIG. 9B, the receiving flange 11F and the stator supporting shoulders 21, 2TA of the stator legs 2S that are attached thereto have a corresponding screw connection 11.2. An analogous situation applies in a corresponding way to the attachment of the rotor legs 3S with corresponding rotor supporting shoulders 22, 3TA to a hub flange 13F. For the sake of simplicity, the designations have been correspondingly presented together in FIG. 9B.

A denoted flange 11F, 13F has in the present case as a supporting flange a second fitting element, which here as a male part (in this embodiment as a fully circumferential tongue) is made to match a female part (in this embodiment as a groove) on the supporting shoulder 2TA, 3TA of the legs 2S, 3S. In the present case, the fully circumferential leg 11S, 13S on the supporting flange 11F, 13F is laterally beveled for the self-adjusting attachment of the leg 2S, 3S and for introduction into the groove 2N, 3N that respectively extends over part of the inner circumference. In the present case, the front face SF1, SF2 is formed as essentially extending parallel to the connection plane of the supporting shoulder 2TA, 3TA and the supporting flange 11F, 13F, while the side face A1, A2 extends at an angle other than a right angle to the connection plane of the supporting shoulder 2TA, 3TA and of the supporting flange 11F, 13F. Between the front faces SF1 and SF2 there remains a clearance F; this and the beveling are correspondingly indicated on the side faces A1, A2.

Subsequently, in a step S2—as shown in principle in FIG. 6—the journal 12 is joined onto the receiving pin 11, which also holds the receiving flange 11F for the stator support 2A. In the case of the on-site assembly preferred here, however (unlike as shown in FIG. 6 for explanation), it is initially provided that only the receiving pin 11 with the receiving flange 11F and the stator support 2A as well as the journal 12 and the hub 13 is formed as a partially assembled component of the generator supporting system 5 for the adding on of a generator support 10, as shown in FIG. 10. In the third step S3 shown here, the partially assembled generator support 10—that is to say initially only the stator support 2A—is made available on the receiving pin 11 and the journal 12 and also the hub 13 and by way of the stator support attached to the receiving flange 11F in step S3.

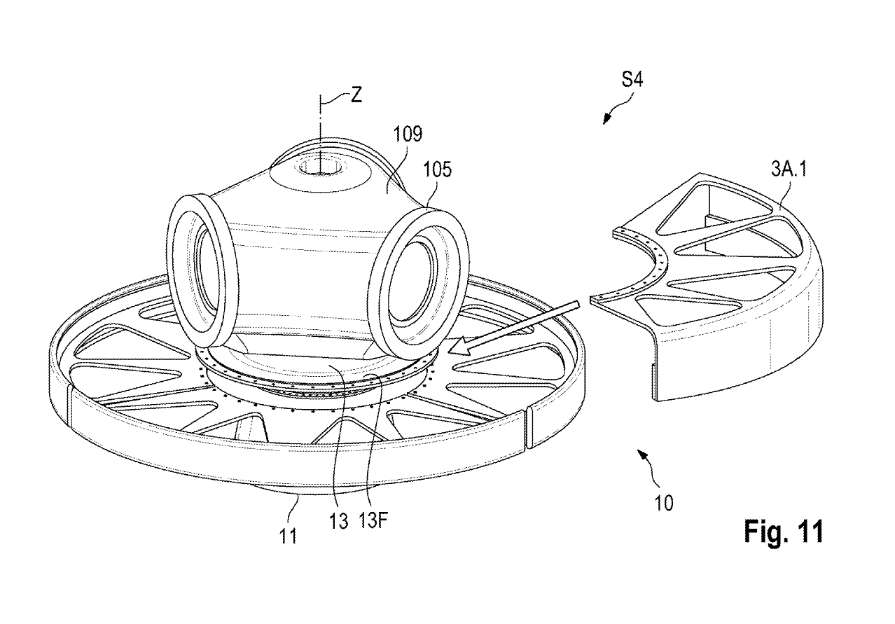

Furthermore, in a further step S4, the rotor support is assembled as a multielement rotor support 3A with a number of rotor support elements 3A.1, 3A.2, 3A.3—as can be seen from FIG. 11—on the partially assembled generator supporting system 5 shown in FIG. 10. To be precise, in step S4 the rotor support 3A—as shown in FIG. 11—is attached to the hub flange 13F, by the rotor support elements 3A.1, 3A.2, 3A.3 being pushed in radially with respect to the centering axis Z.

Threading in of the rotor 3 along the centering axis Z depicted in FIG. 11 has consequently become superfluous—rather, operational segments of the rotor 3—that is to say the segments corresponding to the rotor support elements 3A.1, 3A.2, 3A.3—can be pushed in radially and fixed in an operational state on the hub flange 13F.

As can be seen in FIG. 10 and FIG. 11, consequently a system comprising a multielement stator support 2A and a multielement rotor support 3A is initially formed for providing a multielement generator support 10. According to step S4, this generator support 10 is designed such that the stator support 2A and the rotor support 3A are assembled on the generator supporting system 5 shown.

The system of a generator support 10 is therefore only attached to the hub flange 13F on the hub 13 step by step, and not as a whole, indeed with the rotor support elements 3A.1, 3A.2, 3A.3 being subsequently introduced radially in an individualized manner in step S4, in a way that can be seen from FIG. 11. At that point in time, as can be seen in FIG. 10, the rotor hub 13 or 109 with the journal 12 has already been attached to the receiving pin 11 with the receiving flange 11F and the stator support 2A according to step S3.

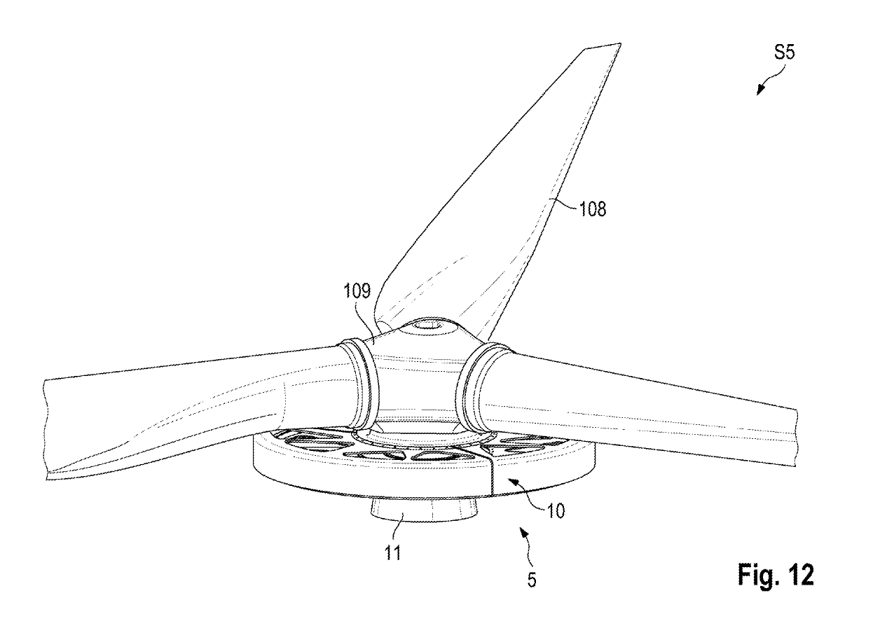

Finally, as can be seen in FIG. 12, in a further step S5, the rotor blades 108 of the rotor are attached to the blade flange bearings 105 of the rotor hub 109, so that this results in a construction such as that which can be seen assembled in FIG. 12 as a generator supporting system 10 with rotor. In this way, during the on-site assembly explained here, a generator support 10 with a rotor hub 109 and rotor blades 108—that is to say almost the entire generator supporting system 5 with rotor as can be seen in FIG. 12—can be assembled on the ground.

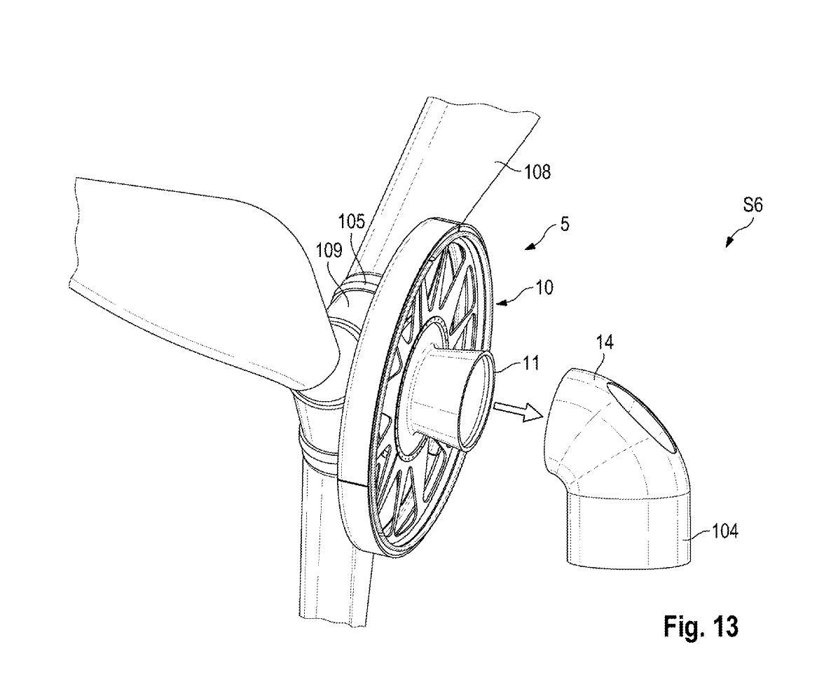

Then, in a further step S6—as can be seen in FIG. 13—the entire generator supporting system 5 with rotor can be attached as a whole with the receiving pin 11 to the bed plate 14 of a top flange 104 of a tower 102 for a wind turbine. This finally produces in FIG. 13 the operationally ready generator system 5 on the basis of the generator supporting system 10 for a wind turbine of FIG. 1 and FIG. 2 in the explained step S6.

1. A support element for forming a support of a ring generator, the support element comprising:
an outer-circumferential supporting ring for attachment of a winding,
an inner-circumferential supporting shoulder for linking up with a pin for connection to a bed plate, and
a leg assigned to a sector of an area of the generator surface and designed for the assembly of the outer-circumferential supporting ring,
the leg being coupled to the inner-circumferential supporting shoulder that extends over part of the inner circumference for attachment to a fully circumferential supporting flange, and
the inner-circumferential supporting shoulder having a first fitting element and the fully circumferential supporting flange having a second fitting element, the first and second fitting elements being made to mate with one another in a fitting manner.

2. The support element as claimed in claim 1, wherein:
the first fitting element is designed as a groove that extends over part of the inner circumference of the inner-circumferential supporting shoulder and the second fitting element is designed as a fully circumferential tongue on the fully circumferential supporting flange; or
the first fitting element is designed as a tongue that extends over part of the inner circumference of the inner-circumferential supporting shoulder and the second fitting element is designed as a fully circumferential groove on the fully circumferential supporting flange.

3. The support element as claimed in claim 1, wherein at least one of the first fitting element or the second fitting element has a front face and a side face, the front face extending obliquely in relation to the side face.

4. The support element as claimed in claim 3, wherein at least one of:
the front face extends parallel to a connection plane of the inner-circumferential supporting shoulder and of the fully circumferential supporting flange and the side face extends at an angle other than a right angle to the front face,
the side face extends at a right angle to the connection plane of the inner-circumferential supporting shoulder and of the fully circumferential supporting flange and the front face extends at an angle other than a right angle to the side face, or
the side face extends at an angle other than a right angle to the connection plane of the inner-circumferential supporting shoulder and of the fully circumferential supporting flange and the front face extends in a plane other than parallel to the connection plane of the inner-circumferential supporting shoulder and of the supporting flange.

5. The support element as claimed in claim 1, wherein:
the support element is one of a stator support element for a stator support of a ring generator or a rotor support element for a rotor support of a ring generator, and
at least one of the inner-circumferential supporting shoulder or the fully circumferential supporting flange has a perforation for leading through a screw, a bolt or similar holding element in order to securely connect the inner-circumferential supporting shoulder and the fully circumferential supporting flange to one another in a releasable manner.

6. The support element as claimed in claim 5, wherein the perforation comprises a row of holes with a plurality of holes for leading through a plurality of screws, bolts or holding elements in order to securely connect the inner-circumferential supporting shoulder and the fully circumferential supporting flange to one another in a releasable manner.

7. A stator support of a ring generator, the stator support comprising:
a plurality of stator support elements assembled over a generator surface, wherein each of the stator support elements includes:
an outer-circumferential stator supporting ring for attachment of a stator winding,
an inner-circumferential stator supporting shoulder for the indirect attachment to a receiving pin, wherein the receiving plate is configured to be coupled to a bed plate, and
a stator leg assigned to a sector of an area of the generator surface and designed for the assembly of the outer-circumferential stator supporting ring,
the stator leg being provided with the stator supporting shoulder that extends over part of the inner circumference for attachment to a fully circumferential supporting flange, the fully circumferential supporting flange being provided as a receiving flange for attachment to the receiving pin for connection to a bed plate, the stator supporting shoulder having a first fitting element and the receiving flange having a second fitting element, the first and second fitting elements being made to mate with one another in a fitting manner.

8. The stator support as claimed in claim 8, wherein
the stator leg has a radially extending stator supporting arm and a stator supporting ring segment that extends over the outer circumference and couples to the stator supporting arm for forming the stator supporting ring, and
the supporting ring is formed with a turned arrangement of various stator support elements, and consequently with a circumferential offset of various stator supporting ring segments.

9. The stator support as claimed in claim 7, wherein
the stator supporting arm integrally adjoins the stator supporting shoulder that extends over part of the inner circumference radially in relation to a centering axis, wherein the stator supporting shoulder extends over part of the inner circumference is designed to be securely connected in a releasable manner to the receiving flange and the receiving flange is designed to be securely connected in a releasable manner to the receiving pin.

10. The stator support as claimed in claim 7, wherein at least one of the stator supporting arm and the stator leg forms a flat part covering the sector of an area.

11. The stator support as claimed in claim 7, wherein the stator supporting arm is adjoined by a stator supporting ring segment that is a bordering frame and T-shaped in cross section.

12. A rotor support of a ring generator, the rotor support comprising:
a plurality of rotor support elements assembled over a generator surface, wherein the rotor support is designed with an outer-circumferential rotor supporting ring for the attachment of a rotor winding and with an inner-circumferential rotor supporting shoulder, wherein the rotor support is designed for being indirectly attached to a rotor hub mounted on a journal, by the rotor supporting shoulder that extends over the inner circumference, wherein each of the rotor support element has:
a rotor leg that is a segment of a circle and is assigned to a sector of an area of the generator surface and designed for the assembly of the rotor supporting ring,
the rotor leg being coupled with the rotor supporting shoulder that extends over part of the inner circumference for attachment to a fully circumferential supporting flange, the fully circumferential supporting flange being provided as a hub flange for attachment to a hub, the hub being provided on a journal for connection to a receiving pin and the latter to a bed plate, and
the rotor supporting shoulder having a first fitting element and the hub flange having a second fitting element, the first and second fitting elements being made to mate with one another in a fitting manner.

13. The rotor support as claimed in claim 12, wherein the rotor leg has a radially extending rotor supporting arm and a rotor supporting ring segment that extends over the outer circumference and is coupled to the rotor supporting arm for forming the rotor supporting ring, and
the rotor supporting ring is to be formed with a turned arrangement of various rotor support elements, and consequently with a circumferential offset of various rotor supporting ring segments.

14. The rotor support as claimed in claim 12, wherein
the rotor supporting arm integrally adjoin the rotor supporting shoulder that extends over part of the inner circumference radially in relation to a centering axis, wherein the hub flange is designed to be securely connected in a releasable manner to the hub.

15. The rotor support as claimed in claim 12, wherein at least one of a rotor supporting arm or a rotor leg is a flat part covering the sector of an area.

16. The rotor support as claimed in claim 12, wherein the rotor supporting arm is adjoined by a rotor supporting ring segment that is a bordering frame and L-shaped in cross section.

17. (canceled)

18. The stator support as claimed in claim 7, wherein each of the stator support elements are configured to be removed from another adjacent support element and attached again.

19. A generator support comprising a stator support and a rotor support as claimed in claim 12, wherein the rotor support circumferentially surrounds the stator support.

20. (canceled)

21. A ring generator of a synchronous generator, comprising:
the generator support as claimed in claim 19, wherein the stator support carries a stator winding with a plurality of stator pole packs, and the rotor support carries a rotor winding with a plurality of rotor pole packs.

22. The generator as claimed in claim 21, wherein each of the rotor support elements is designed with an electrical connection of its own.

23. The generator as claimed in claim 21, wherein
for an operational generator function of its own, to each of the stator support elements with a stator winding and/or to each of the rotor support elements with a rotor winding
there is respectively connected a rectifier, a DC conductor, an inverter and a transformer, for forming in each case an own operational connection to a power supply connection for the own operational generator function.

24. A generator supporting system with a generator as claimed in claim 20, having:
a receiving pin for supporting the stator for attachment to
a bed plate, the stator support with a stator supporting shoulder that extends over part of the inner circumference being attached to the receiving pin for the releasably fixed connection to a receiving flange, and
a journal for the attachment of a rotor hub, the rotor support with the rotor supporting shoulder that extends over part of the inner circumference being provided on the rotor hub for attachment to the hub flange.

25. The generator supporting system as claimed in claim 24, wherein
the receiving flange on the receiving pin is fitted directly on the receiving pin and securely surrounds the receiving pin of the bed plate, and
the hub flange is attached directly to the rotor hub and surrounds the journal in a freely rotatable manner.

26. A nacelle of a wind turbine comprising a rear nacelle casing and with a generator supporting system as claimed in claim 24 and a rotor comprising the rotor hub as a continuation of the rear nacelle casing.

27. The nacelle as claimed in claim 26, wherein the generator supporting system with the generator is surrounded by the nacelle casing and the rotor hub.

28. The nacelle as claimed in claim 26, wherein the generator supporting system is surrounded by the nacelle casing, the generator protruding between the rotor hub and the rear nacelle casing.

29. A wind turbine comprising:
a tower with a top flange, and
a nacelle with a generator supporting system as claimed in claim 24, the bed plate being connected to the top flange and the nacelle having a rear nacelle casing, and
a rotor comprising a rotor hub as a continuation of the rear nacelle casing.

30. The wind turbine as claimed in claim 29, wherein the wind turbine is a gearless wind turbine, and wherein the generator is a synchronous generator as a slow runner and a ring generator.

31-32. (canceled)

33. The support element as claimed in claim 1, wherein the support element is assembled with a number of support elements over a generator surface, wherein the leg is in the form a segment of a circle.

34. The support element as claimed in claim 1, wherein the leg is provided integrally with the inner-circumferential supporting shoulder that extends over part of the inner circumference for attachment to a fully circumferential support flange.
